(19) United States
(12) Patent Application Publication
(10) Pub. No.: US 2022/0172242 A1
(43) Pub. Date: Jun. 2, 2022

(54) SYSTEM AND METHOD FOR AUTOMATED DISCOUNT RECOMMENDATIONS BASED ON BUSINESS SCENARIO AND INDIRECT USER RESPONSE

(71) Applicant: Aviso, Inc., Redwood City, CA (US)

(72) Inventors: Joy MUSTAFI, Hyderabad (IN); Sayan Deb KUNDU, Kolkata (IN); Nishan Sk ALI, Bagnan (IN); Trevor RODRIGUES, Scottsdale (US)

(73) Assignee: Aviso, Inc., Redwood City, CA (US)

(21) Appl. No.: 17/110,033

(22) Filed: Dec. 2, 2020

(51) Int. Cl. G06Q 30/02; G06Q 40/00; G06Q 30/00; G06F 16/9535; G06N 20/00; G06N 5/04

(52) U.S. Cl. CPC G06Q 30/0224; G06Q 40/12; G06Q 30/016; G06N 5/04; G06Q 30/0205; G06F 16/9535; G06N 20/00; G06Q 30/0206

(57) ABSTRACT

A system (100) and method for automated discount recommendations. The system (100) includes a customer relationship management database (102), a server computer (104), and a user device (112). A system processing unit (106) extracts data from the customer relationship management database (102), and further uses the trained artificial intelligence based classification model to identify the open deals that are on risk. Then the system processing unit (106) uses the trained machine learning scoring model, to recommends best optimize sales quote to sales representative for winning the deal. A system server memory (120) stores computer-readable instructions, the trained artificial intelligence based. classification model and the trained machine learning scoring model. The user device (112) is connected to the server computer (104). A sales representative receives optimize sales quote, on a user device (116), for winning the deal.

### FIELD OF INVENTION

The present invention relates to a system and methods for automated discount recommendations, and more specifically relates to a. system and method for automated discount recommendations based on business scenario and indirect user response.

Multiple companies have been operating in the same field nowadays. Thus there is huge competition in the market. The companies have to Even with a slight delay in making the decision, results in loss of the sales deals. If there is a large company, then it is also difficult to make a decision quickly. Some it is difficult to find under performance of sales representative and factor affecting sales representative performance. Thus ultimately the sales target of a particular sales representative does not achieve.

This also very challenging to quote best sale price to the customer. Sales representative have to quote price that encourages customer to close the deals and at the same provide good profit to company. But there is no existing solution to move a step further by assisting the business with an optimum price of the deal which would not only increase the chances of winning but also would ensure profitability based on the historical records of won deals

Patent application US2020/134683A1 discloses computing systems, database systems, and related methods are provided for guiding a user defining a quote for a product. One method involves a server obtaining one or more values for one or more attributes of a quote from a client device coupled to the server over a network, obtaining an expected pricing model for the quote from a database, determining expected pricing information for the quote based on the one or more values for the one or more attributes using the model, and providing a graphical indication of the expected pricing information on the client device. The expected pricing model is determined based on historical relationships between quote attributes and price for previously-closed quotes.

The existing invention does not provide proper optimized quote. The existing invention does not look into the interaction history and customer response. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a system and method for automated discount recommendations based on business scenario and indirect user response. The method includes:

A method of creating temporal dataset of lost deal, the method having: A system processing unit of a server computer executes computer-readable instructions to retrieve data from a customer relationship management database. The system processing unit executes computer-readable instructions to create temporal dataset of lost deal based on appropriate set of features, The system processing unit executes computer-readable instructions to refine and quantify the temporal dataset of lost deal.

A method of creating a temporal dataset of won deal, the method having: The system processing unit of the server computer executes computer-readable instructions to retrieve data from the customer relationship management database. The system processing unit executes computer-readable instructions to create a temporal dataset of won deal based on appropriate set of features. The system processing unit executes computer-readable instructions to refine and quantify the temporal dataset of won deal.

A method of the training an artificial intelligence based classification model to identify the open deals that are on risk, the method having: Further, the system processing unit executes computer-readable instructions to integrate all the temporal dataset of lost deal and feed the temporal dataset of lost deal into the artificial intelligence based. classification model. The artificial intelligence based classification model is trained to identify the pattern of transition for lost deals from the temporal dataset of lost deal. The trained artificial intelligence based classification model is able to identify the open deals that are on risk. The trained artificial intelligence based classification model is tested and optimized. The trained artificial intelligence based classification model is stored in a system server memory of the server computer.

A method of the training a machine learning scoring model to predict optimal deal amount for wining open deals, the method having: The system processing unit executes computer-readable instructions to integrate all the temporal dataset of won deal and feed the temporal dataset of won deal into the machine learning scoring model. The machine learning scoring model is trained to predict optimal deal amount for wining open deals with help of the temporal dataset of won deal. The trained machine learning scoring model is tested and optimized. The trained machine learning scoring model is stored in a system server memory of the server computer.

A method for automated discount recommendations for wining open deals, the method having: The system processing unit of the server computer executes computer-readable instructions to extract data of deals from the customer relationship management database and the system processing unit creates a temporal dataset of open deals. The system processing unit feeds the temporal dataset of open deals into the trained artificial intelligence based classification model. The trained artificial intelligence based classification model compares the pattern of lost deals with the temporal dataset of open deals. Thus, the trained artificial intelligence based classification model identifies the open deals that are on risk of being lost. The system processing unit of the server computer executes computer-readable instructions to feed the data of open deals that are on risk into the trained machine learning scoring model. The trained machine learning scoring model predicts the optimal amount for open deals that are on risk so that probability of same to be won is maximized. The system processing unit of the server computer executes computer-readable instructions to calculate difference between the quoted amount and the predicted optimal amount for the open deals that are on risk. Thus, the system processing unit of the server computer executes computer-readable instructions recommends the discount amount to sales representative, wherein, the discount amount is difference between the quoted amount and the predicted optimal amount for the open deals that are on risk of being lost.

The main advantage of the present invention is that the present invention provides a statistically verifiable solution which has yielded positive results.

Yet another advantage of the present invention is that the present invention automates the next automated discount recommendations.

Yet another advantage of the present invention is that the present invention identifies the deals which may lead to loss based on the pattern of transition of the progress.

Yet another advantage of the present invention is that the present invention provides competitive edge for many of the deals which might have been lost but with an appropriate pricing recommendation they could be converted into success.

Further objectives, advantages, and features of the present invention will become apparent from the detailed description provided hereinbelow, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the system of the present invention.

### DETAILED DESCRIPTION OF THE INVENTION

Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

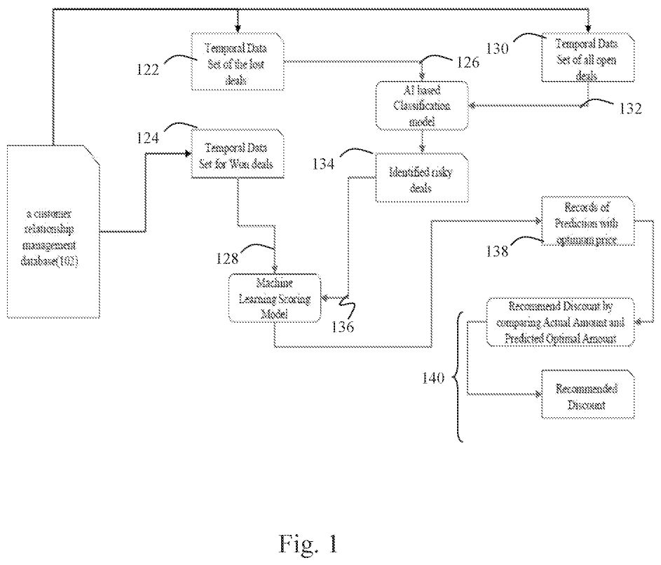

FIG. 1 illustrates a flowchart for automated discount recommendations for based on business scenario and indirect user response. In step (122), a method of creating temporal dataset of lost deal having: a system processing unit (106) of a server computer (104) executes computer-readable instructions to retrieve data from a customer relationship management database (102). The system processing unit (106) executes computer-readable instructions to create temporal dataset of lost deal based on appropriate set of features. The system processing unit (106) executes computer-readable instructions to refine and quantify the temporal dataset of lost deal. In step (124), a method of creating a temporal dataset of won deal having: The system processing unit (106) of the server computer (104) executes computer-readable instructions to retrieve data from the customer relationship management database (102). The system processing unit (106) executes computer-readable instructions to create a temporal dataset of won deal based on appropriate set of features. The system processing unit (106) executes computer-readable instructions to refine and quantify the temporal dataset of won deal. In step(126), a method of the training an artificial intelligence based classification model to identify the open deals that are on risk, having: Further, the system processing unit (106) executes computer-readable instructions to integrate all the temporal dataset of lost deal and feed the temporal dataset of lost deal into the artificial intelligence based classification model. The artificial intelligence based classification model is trained to identify the pattern of transition for lost deals from the temporal dataset of lost deal. The trained artificial intelligence based classification model is able to identify the open deals that are on risk. The trained artificial intelligence based classification model is tested and optimized. The trained artificial intelligence based classification model is stored in a system server memory (120) of the server computer (104). In step (128), a method of the training a machine learning scoring model to predict optimal deal amount for wining open deals, having: The system processing unit (106) executes computer-readable instructions to integrate all the temporal dataset of won deal and feed the temporal dataset of won deal into the machine learning scoring model. The machine learning scoring model is trained to predict optimal deal amount for wining open deals with help of the temporal dataset of won deal. The trained machine learning scoring model is tested and optimized. The trained machine learning scoring model is stored in a system server memory (120) of the server computer (104), In step (130), the system processing unit (106) of the server computer (104) executes computer-readable instructions to extract data of deals from the customer relationship management database (102) and the system processing unit (106) creates a temporal dataset of open deals. In step (132), the system processing unit (106) feeds the temporal dataset of open deals into the trained artificial intelligence based classification model. In step (134), the trained artificial intelligence based classification model compares the pattern of lost deals with the temporal dataset of open deals. Thus, the trained artificial intelligence based classification model identifies the open deals that are on risk of being lost. In step (136), the system processing unit (106) of the server computer (104) executes computer-readable instructions to feed the data of open deals that are on risk into the trained machine learning scoring model. In step (138), the trained machine learning scoring model predicts the optimal amount for open deals that are on risk so that probability of same to be won is maximized. In step (140), the system processing unit (106) of the server computer (104) executes computer-readable instructions to calculate difference between the quoted amount and the predicted optimal amount for the open deals that are on risk. Thus, the system processing unit (106) of the server computer (104) executes computer-readable instructions recommends the discount amount to sales representative.

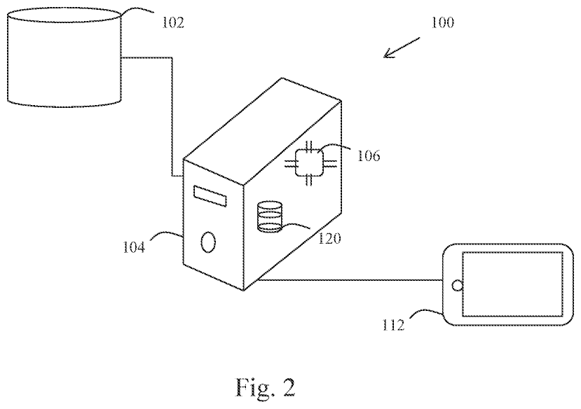

FIG. 2 illustrates a system (100) for automated discount recommendations based on business scenario and indirect user response. The system (100) includes a customer relationship management database (102), a server computer (104), and a user device (112). The server computer (104) includes a system processing unit (106), and a system server memory (120). The system server memory (120) stores computer-readable instructions, the trained artificial intelligence based classification model and the trained machine learning scoring model. The user device (112) is connected to the server computer (104). A sales representative receives optimize sales quote, on the user device (116), for winning the deal.

The present invention relates to a system and method for automated discount recommendations based on business scenario and indirect user response. The method includes:

A method of creating temporal dataset of lost deal, the method having

a system processing unit of a server computer, executes computer-readable instructions to retrieve data from a customer relationship management database;

the system processing unit executes computer-readable instructions to create temporal dataset of lost deal based on appropriate set of features; and

The system processing unit executes computer-readable instructions to refine and quantify the temporal dataset of lost deal.

In the preferred embodiment, the system processing unit executes computer-readable instructions to create the temporal dataset of lost deal based on appropriate set of features that include, but not limited to, list price, sales price, quote object, stock market data, type of deal, industry, region, account, average revenue of account, performance of sales rep, competitor, product.

A method of creating a temporal dataset of won deal, the method having

the system processing unit of the server computer, executes computer-readable instructions to retrieve data from the customer relationship management database;

the system processing unit executes computer-readable instructions to create a temporal dataset of won deal based on appropriate set of features; and

the system processing unit executes computer-readable instructions to refine and quantify the temporal dataset of won deal.

In the preferred embodiment, the system processing unit executes computer-readable instructions to create the temporal dataset of won deal based on appropriate set of features that include, but not limited to, list price, sales price, quote object, stock market data, type of deal, industry, region, account, average revenue of account, performance of sales rep, competitor, product.

A method of the training an artificial intelligence based classification model to identify the open deals that are on risk, the method having

further, the system processing unit executes computer-readable instructions to integrate all the temporal dataset of lost deal and feed the temporal dataset of lost deal into the artificial intelligence based classification model;

the artificial intelligence based classification model is trained to identify the pattern of transition for lost deals from the temporal dataset of lost deal;

the trained artificial intelligence based classification model is able to identify the open deals that are on risk;

the trained artificial intelligence based classification model is tested and optimized; and

the trained artificial intelligence based classification model is stored in a system server memory of the server computer.

A method of the training a machine learning scoring model to predict optimal deal amount for wining open deals, the method having

the system processing unit executes computer-readable instructions to integrate all the temporal dataset of won deal and feed the temporal dataset of won deal into the machine learning scoring model;

the machine learning scoring model is trained to predict optimal deal amount for wining open deals with help of the temporal dataset of won deal;

the trained machine learning scoring model is tested and optimized; and

the trained machine learning scoring model is stored in a system server memory of the server computer.

In the preferred embodiment, machine learning scoring model is polynomial regression based machine learning model.

A method for automated discount recommendations for wining open deals, the method having

the system processing unit of the server computer executes computer-readable instructions to extract data of deals from the customer relationship management database and the system processing unit creates a temporal dataset of open deals;

the system processing unit feeds the temporal dataset of open deals into the trained artificial intelligence based classification model;

the trained artificial intelligence based classification model compares the pattern of lost deals with the temporal dataset of open deals;

thus, the trained artificial intelligence based classification model identifies the open deals that are on risk of being lost;

the system processing unit of the server computer executes computer-readable instructions to feed the data of open deals that are on risk into the trained machine learning scoring model;

the trained machine learning scoring model predicts the optimal amount for open deals that are on risk so that probability of same to be won is maximized;

the system processing unit of the server computer executes computer-readable instructions to calculate difference between the quoted amount and the predicted optimal amount for the open deals that are on risk, and

thus, the system processing unit of the server computer executes computer-readable instructions recommends the discount amount to sales representative, wherein, the discount amount is difference between the quoted amount and the predicted optimal amount for the open deals that are on risk of being lost.

In the preferred embodiment, the system processing unit recommends the discount amount to sales representative on a user device. In the preferred embodiment, the user device includes, but not limited to, a desktop computer, a laptop, a tablet, a smartphone, a mobile phone.

In an embodiment, the present invention relates to a system and method for automated discount recommendations based on business scenario and indirect user response. The method includes:

A method of creating temporal dataset of lost deal, the method having

one or more system processing units of a server computer, execute computer-readable instructions to retrieve data from a customer relationship management database;

the one or more system processing units execute computer-readable instructions to create temporal dataset of lost deal based on appropriate set of features; and

the one or more system processing units execute computer-readable instructions to refine and quantify the temporal dataset of lost deal.

In the preferred embodiment, the one or more system processing units execute computer-readable instructions to create the temporal dataset of lost deal based on appropriate set of features that include, but not limited to, list price, sales price, quote object, stock market data, type of deal, industry, region, account, average revenue of account, performance of sales rep, competitor, product.

A method of creating a temporal dataset of won deal, the method having

the one or more system processing units of the server computer, execute computer-readable instructions to retrieve data from the customer relationship management database;

the one or more system processing units execute computer-readable instructions to create a temporal dataset of won deal based on appropriate set of features; and

the one or more system processing units execute computer-readable instructions to refine and quantify the temporal dataset of won deal.

In the preferred embodiment, the one or more system processing units execute computer-readable instructions to create the temporal dataset of won deal based on appropriate set of features includes, but not limited to, list price, sales price, quote object, stock market data, type of deal, industry, region, account, average revenue of account, performance of sales rep, competitor, product.

A method of the training an artificial intelligence based classification model to identify the open deals that are on risk, the method having

further, the one or more system processing units execute computer-readable instructions to integrate all the temporal dataset of lost deal and feed the temporal dataset of lost deal into the artificial intelligence based classification model;

the artificial intelligence based classification model is trained to identify the pattern of transition for lost deals from the temporal dataset of lost deal;

the trained artificial intelligence based classification model is able to identify the open deals that are on risk;

the trained artificial intelligence based classification model is tested and optimized; and

the trained artificial intelligence based classification model is stored in a system server memory of the server computer.

A method of the training a machine learning scoring model to predict optimal deal amount for wining open deals, the method having

the one or more system processing units execute computer-readable instructions to integrate all the temporal dataset of won deal and feed the temporal dataset of won deal into the machine learning scoring model;

the machine learning scoring model is trained to predict optimal deal amount for wining open deals with help of the temporal dataset of won deal;

the trained machine learning scoring model is tested and optimized; and

the trained machine learning scoring model is stored in a system server memory of the server computer.

In the preferred embodiment, machine learning scoring model is polynomial regression based machine learning model.

A method for automated discount recommendations for wining open deals, the method having

the one or more system processing units of the server computer execute computer-readable instructions to extract data of deals from the customer relationship management database and the one or more system processing units create a temporal dataset of open deals;

the one or more system processing units feed the temporal dataset of open deals into the trained artificial intelligence based classification model;

the trained artificial intelligence based classification model compares the pattern of lost deals with the temporal dataset of open deals;

thus, the trained artificial intelligence based classification model identifies the open deals that are on risk of being lost;

the one or more system processing units of the server computer execute computer-readable instructions to feed the data of open deals that are on risk into the trained machine learning scoring model;

the trained machine learning scoring model predicts the optimal amount for open deals that are on risk so that probability of same to be won is maximized;

the one or more system processing units of the server computer execute computer-readable instructions to calculate difference between the quoted amount and the predicted optimal amount for the open deals that are on risk; and

thus, the one or more system processing units of the server computer execute computer-readable instructions recommend the discount amount to sales representative, wherein, the discount amount is difference between the quoted amount and the predicted optimal amount for the open deals that are on risk of being lost.

In the preferred embodiment, the one or more system processing units recommend the discount amount to sales representative on one or more user devices. In the preferred embodiment, the one or more user devices include, but not limited to, a desktop computer, a laptop, a tablet, a smartphone, a mobile phone.

In an embodiment, the method for automated discount recommendations based on business scenario and indirect user response is being executed with the help of a system. The system includes a customer relationship management database, a server computer, and a user device. The customer relationship management database stores all data related to the company's historical sales and deals, wherein, the customer relationship management is all connected to the server computer. The server computer includes a system processing unit, and a system server memory. The system processing unit executes computer-readable instructions uses the trained artificial intelligence based classification model to identify the open deals that are on risk. Then the system processing unit uses the trained machine learning scoring model, to recommends best optimize sales quote to sales representative for winning the deal. The system server memory stores computer-readable instructions, the trained artificial intelligence based classification model and the trained machine learning scoring model. The user device is connected to the server computer. A sales representative receives optimize sales quote, on the user device, for winning the deal. Herein, the system processing unit extracts data from the customer relationship management database, and further uses the trained artificial intelligence based classification model to identify the open deals that are on risk. Then the system processing unit uses the trained machine learning scoring model, to recommends best optimize sales quote to sales representative for winning the deal.

In the preferred embodiment, the customer relationship management database stores all data related to the company's historical sales and deals under following categories list price, sales price, quote object, stock market data, type of deal, industry, region, account, average revenue of account, performance of sales rep, competitor, product.

In an embodiment, the method for automated discount recommendations based on business scenario and indirect user response is being executed with the help of a system. The system includes a customer relationship management database, a server computer, and one or more user devices. The customer relationship management database stores all data related to the company's historical sales and deals, wherein, the customer relationship management is all connected to the server computer. The server computer includes one or more system processing units, and a system server memory. The one or more system processing units execute computer-readable instructions uses the trained artificial intelligence based classification model to identify the open deals that are on risk. Then the one or more system processing units use the trained machine learning scoring model, to recommend best optimize sales quote to sales representative for winning the deal. The system server memory stores computer-readable instructions, the trained artificial intelligence based classification model and the trained machine learning scoring model. The one or more user devices are connected to the server computer. A sales representative receives optimize sales quote, on the one or more user devices, for winning the deal. Herein, the one or more system processing units extract data from the customer relationship management database, and further use the trained artificial intelligence based classification model to identify the open deals that are on risk. Then the one or more system processing units use the trained machine learning scoring model, to recommend best optimize sales quote to sales representative for winning the deal.

In the preferred embodiment, the customer relationship management database stores all data related to the company's historical sales and deals under following categories list price, sales price, quote object, stock market data, type of deal, industry, region, account, average revenue of account, performance of sales rep, competitor, product.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim

1. A system (100) and method for automated discount recommendations based on business scenario and indirect user response, the method comprising:
a method of creating temporal dataset of lost deal, the method having
An at least one system processing unit (106) of a server computer (104), executes computer-readable instructions to retrieve data from a customer relationship management database (102),
the at least one system processing unit (106) executes computer-readable instructions to create temporal dataset of lost deal based on appropriate set of features, and
the at least one system processing unit (106) executes computer-readable instructions to refine and quantify the temporal dataset of lost deal;
a method of creating a temporal dataset of won deal, the method having
the at least one system processing unit (106) of the server computer (104), executes computer-readable instructions to retrieve data from the customer relationship management database (102),
the at least one system processing unit (106) executes computer-readable instructions to create a temporal dataset of won deal based on appropriate set of features, and
the at least one system processing unit (106) executes computer-readable instructions to refine and quantify the temporal dataset of won deal;
a method of the training an artificial intelligence based classification model to identify the open deals that are on risk, the method having
further, the at least one system processing unit (106) executes computer-readable instructions to integrate all the temporal dataset of lost deal and feed the temporal dataset of lost deal into the artificial intelligence based classification model,
the artificial intelligence based classification model is trained to identify the pattern of transition for lost deals from the temporal dataset of lost deal,
the trained artificial intelligence based classification model is able to identify the open deals that are on risk,
the trained artificial intelligence based classification model is tested and optimized, and
the trained artificial intelligence based classification model is stored in a system server memory (120) of the server computer (104);
a method of the training a machine learning scoring model to predict optimal deal amount for wining open deals, the method having
the at least one system processing unit (106) executes computer-readable instructions to integrate all the temporal dataset of won deal and feed the temporal dataset of won deal into the machine learning scoring model,
the machine learning scoring model is trained to predict optimal deal amount for wining open deals with help of the temporal dataset of won deal,
the trained machine learning scoring model is tested and optimized, and the trained machine learning scoring model is stored in a system server memory (120) of the server computer (104); and
a method for automated discount recommendations for wining open deals, the method having
the at least one system processing unit (106) of the server computer (104) executes computer-readable instructions to extract data of deals from the customer relationship management database (102.) and the at least one system processing unit (106) creates a temporal dataset of open deals,
the at least one system processing unit (106) feeds the temporal dataset of open deals into the trained artificial intelligence based classification model,
the trained artificial intelligence based classification model compares the pattern of lost deals with the temporal dataset of open deals,
thus, the trained artificial intelligence based classification model identifies the open deals that are on risk of being lost,
the at least one system processing unit (106) of the server computer (104) executes computer-readable instructions to feed the data of open deals that are on risk into the trained machine learning scoring model,
the trained machine learning scoring model predicts the optimal amount for open deals that are on risk so that probability of same to be won is maximized,
the at least one system processing unit (106) of the server computer (104) executes computer-readable instructions to calculate difference between the quoted amount and the predicted optimal amount for the open deals that are on risk, and
thus, the at least one system processing unit (106) of the server computer(104) executes computer-readable instructions recommends the discount amount to sales representative, wherein, the discount amount is difference between the quoted amount and the predicted optimal amount for the open deals that are on risk of being lost.

2. The method as claimed in claim 1, wherein, the at least one system processing unit (106) executes computer-readable instructions to create the temporal dataset of lost deal based on appropriate set of features that are selected from list price, sales price, quote object, stock market data, type of deal, industry, region, account, average revenue of account, performance of sales rep, competitor, product.

3. The method as claimed in claiml, wherein, the at least one system processing unit (106) executes computer-readable instructions to create the temporal dataset of won deal based on appropriate set of features that are selected from list price, sales price, quote object, stock market data, type of deal, industry, region, account, average revenue of account, performance of sales rep, competitor, product.

4. The method as claimed in claim 1, wherein, machine learning scoring model is polynomial regression based machine learning model.

5. The method as claimed in claim 1, wherein, the at least one system processing unit (106) recommends the discount amount to sales representative on an at least one user device (112).

6. The at least one user device (112) as claimed in claim 5, wherein, the at least one user device (112) is selected from a desktop computer, a laptop, a tablet, a smartphone, a mobile phone 1.

7. The method as claimed in claim 1, wherein the method for automated discount recommendations based on business scenario and indirect user response, is being executed with the help of a system (100), the system (100) comprising:
the customer relationship management database (102), the customer relationship management database(102) stores all data related to the company's historical sales and deals, wherein, the customer relationship management is all connected to the server computer(104);
the server computer (104), the server computer (104) having
the at least one system processing unit (106), the at least one system processing unit (106) executes computer-readable instructions that uses the trained artificial intelligence based classification model to identify the open deals that are on risk and then uses the trained machine learning scoring model, to recommends best optimize sales quote to sales representative for winning the deal,
the system server memory (120), the system server memory (120) stores computer-readable instructions, the trained artificial intelligence based classification model and the trained machine learning scoring model, and
the at least one user device (112), the at least one user device (112) is connected to the server computer (104), a sales representative receives optimize sales quote, on the at least one user device (116), for winning the deal;
wherein, the at least one system processing unit (106) extracts data from the customer relationship management database (102), and further uses the ⁻trained artificial intelligence based classification model to identify the open deals that are on risk and then uses the trained machine learning scoring model, to recommends best optimize sales quote to sales representative for winning the deal.

8. The customer relationship management database (102) as claimed in claim 7, the customer relationship management database (102) stores all data related to the company's historical sales and deals under following categories list price, sales price, quote object, stock market data, type of deal, industry, region, account, average revenue of account, performance of sales rep, competitor, product.
